(19) United States
(12) Patent Application Publication
(10) Pub. No.: US 2005/0222817 A1
(43) Pub. Date: Oct. 6, 2005

(54) Computer implemented methods and systems for storing product history and/or failure data and/or analyzing causes of component and/or system failure

(75) Inventors: Jose E. Achacoso, Jamaica Plain, MA (US); Jan M. Nygren, Watertown, MA (US); Lucian L. Wagner, Wellesley Hills, MA (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Traceability System Architects, Inc., Newton, MA (US)

(21) Appl. No.: 11/073,852

(22) Filed: Mar. 8, 2005

Related U.S. Application Data
(60) Provisional application No. 60/551,038, filed on Mar. 9, 2004.

(51) Int. Cl. G06F 15/00

(52) U.S. Cl. 702/185

(57) ABSTRACT

Methods and systems are provided for storing and analyzing product history data to determine root causes of performance anomalies and/or field failures. In accordance with some embodiments of the present invention, the life history of an integrated product and its constituent components may be consolidated into a master profile. The master profile may include one or more product profiles and behavior profiles that may be generated from data collected over the product's life history. In response to receiving an indication that an integrated product is defective, the master profile may be analyzed to isolate the component of the integrated product that caused the product to be defective.

### CROSS REFERENCE TO RELATED APPLICATION

This application claims the benefit under 35 U.S.C. § 119(e) of U.S. Provisional Patent Application No. 60/551,038, filed Mar. 9, 2004, which is hereby incorporated by reference herein in its entirety.

### FIELD OF THE INVENTION

The present invention generally relates to the identification of defective products. More particularly, the present invention relates to computer implemented methods and systems for storing and analyzing product history and failure data to determine causes of component and/or system failure.

### BACKGROUND OF THE INVENTION

Help desks and customer service centers are generally used to provide expert assistance to consumers that are having a particular problem with a product. The conventional diagnosis of the particular problem between a customer service representative and a consumer is typically performed over the telephone or, with the advent of the Internet, over e-mail. After learning about a particular problem from a consumer, a customer service representative typically reviews technical manuals, consults with other experts, or asks the consumer follow-up questions before diagnosing the problem and offering a solution. Sometimes, the customer service representative attempts to guide the consumer through one or more lengthy diagnostic tests in order to assist in diagnosing the problem. As a result, these help desks and customer service centers require a large number of customer service representatives that can interact with consumers on a wide variety of problems. They must also be well-versed over a broad spectrum of information related to the product and the particular problem.

However, in the case that the customer service representative is unable to identify the problem, the product is generally returned to a repair center for further analysis and repair. Not only is this a time-consuming and bothersome process, but the inability of the customer service representative to identify the problem deprives the consumer of the product during the pendency of the repair.

At times, the consumer may browse through the manufacturer's support website to retrieve information corresponding to the problem that the consumer has encountered. However, even if a solution to the problem is found on the manufacturer's website, the consumer usually needs to contact a customer service representative for further support with regard to ordering parts and/or components, returning the product, and/or installing the necessary parts and/or components. In addition, while manufacturers repair or replace products and ship the products back to the consumers, manufacturers generally have little idea where the fault occurred within the supply chain (e.g., pre-manufacturing, intra-manufacturing, or post-manufacturing).

Accordingly, it is desirable to provide systems and methods that overcome these and other deficiencies of the prior art.

### SUMMARY OF THE INVENTION

In accordance with the present invention, computer implemented methods and systems are provided for storing and analyzing product history data to determine root causes of performance anomalies and/or field failures.

In accordance with one or more embodiments of the present invention, the life history of a product and its constituent components may be consolidated into a master profile. The master profile may include one or more product profiles that may be generated from data collected over the product's life history (e.g., across the supply chain network). In response to receiving an indication that a product is defective, the master profile associated with the defective product may be accessed. The master profile may be analyzed by comparing the one or more product profiles corresponding to the defective product with product profiles associated with each of the plurality of products to isolate a given attribute that caused the product to be defective. The faulty component of the product may be identified based at least in part on the given attribute.

In one or more embodiments, the attributes comprise at least one of pre-manufacturing, intra-manufacturing, and post-manufacturing attributes.

In one or more embodiments, the master profile includes at least one behavior profile having attributes that characterize a given behavior of the constituent components of the product. The master profile may also include at least one product profile having attributes that characterize the constituent components of the product. The product profile may include information relating to the suppliers of the constituent components of the product. The product profile may be used to determine which supplier provided the faulty component.

In one or more embodiments, the tracing application may isolate a given attribute that caused the product to be defective. In response, the tracing application may determine which products share the same given attribute. Based on the determination, the tracing application may provide the users of those products with a notification.

In one or more embodiments, the supplier that provided the faulty component may be provided with a notification. Users associated with the product may be provided with a notification regarding the faulty component. The notification may be, for example, a product recall notification or a fault notification.

In one or more embodiment, data from reports relating to the product may be collected. The reports may be at least one of logistics data, manufacturing reports, inspection reports, disposition reports, shipping reports, field performance reports, manufacturing process reports, and metrology reports. One or more attributes that are used to define product profiles are generated based at least in part on the collected data.

In accordance with one or more embodiments of the present invention, the tracing application may receive an indication that a user is purchasing a product. In response, the tracing application may access a profile associated with the product and may associate the user with the profile of the product. When a defect is detected in the product, the tracing application may provide the user with a fault notification.

In accordance with one or more embodiments of the present invention, a data repository that includes at least one product profile having attributes that characterize the constituent components of an integrated product may be queried. In response to querying the data repository, a list of steps used to manufacture the integrated product may be provided. In response to receiving an indication that the integrated product is defective, the tracing application may use the product profile to determine which step caused the integrated product to be defective. Upon determining the step that caused the integrated product to be defective, the manufacturer associated with the step may be notified.

There has thus been outlined, rather broadly, at least some of the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

Additional embodiments of the invention, its nature and various advantages, will be more apparent upon consideration of the following detailed description, taken in conjunction with the accompanying drawings, in which like reference characters refer to like parts throughout, and in which:

FIG. 1 is a schematic diagram of an illustrative system suitable for implementation of an application in accordance with some embodiments of the present invention.

FIG. 2 is an example of the server and one of the workstations that may be used in accordance with one or more embodiments of the present invention.

FIG. 3 is an illustration of a master profile that may be used to characterize a product, its components, and associated component attributes.

FIG. 4 is an example of a product genome that describes the product in terms of specific product profiles and generic product profile templates.

FIG. 5 is an illustration of a product profile that includes one or more attribute values and one or more corresponding attribute values.

FIG. 6 is an illustration of a product profile template that provides an approach for determining the attributes of a product or one of its components.

FIG. 7 is an illustration of one example of how a single product profile template may be used in connection with a plurality of product profiles.

FIG. 8 is an illustration showing how attribute properties may be stored in or associated with profile templates.

FIG. 9 is an illustration of a behavior profile that is derived from a behavior profile template.

FIG. 10 is an illustration showing how a profile analysis is performed on profiles of multiple products and/or components that share the same profile templates.

FIG. 11 is an illustration of one example of data repositories.

FIG. 12 is an illustration of how the tracing application allows users to trace faulty parts back to a supplier.

FIG. 13 is an illustration of how the tracing application may allow manufacturers to identify manufacturing sources of failures from the manufacturing processes used to produce the product.

FIG. 14 is an illustration of how the tracing application allows a user or customer having faulty products or products having faulty components to be traced.

FIG. 15 is an illustration showing how the tracing application links trace data after the product has been manufactured and distributed to customers.

FIG. 16 is a flowchart illustrating the steps performed in determining causes of component and/or system failure using a master profile that characterizes the integrated product and its constituent components.

FIG. 17 is an exemplary flowchart illustrating the steps performed in generating a master profile having one or more product profiles and one or more behavior profiles.

FIG. 18 is an exemplary flowchart illustrating the steps performed in analyzing a master profile to identify faults in an integrated product and notifying the appropriate users regarding the fault.

### DETAILED DESCRIPTION OF THE INVENTION

The following description includes many specific details. The inclusion of such details is for the purpose of illustration only and should not be understood to limit the invention. Moreover, certain features which are well known in the art are not described in detail in order to avoid complication of the subject matter of the present invention. In addition, it will be understood that features in one embodiment may be combined with features in other embodiments of the invention.

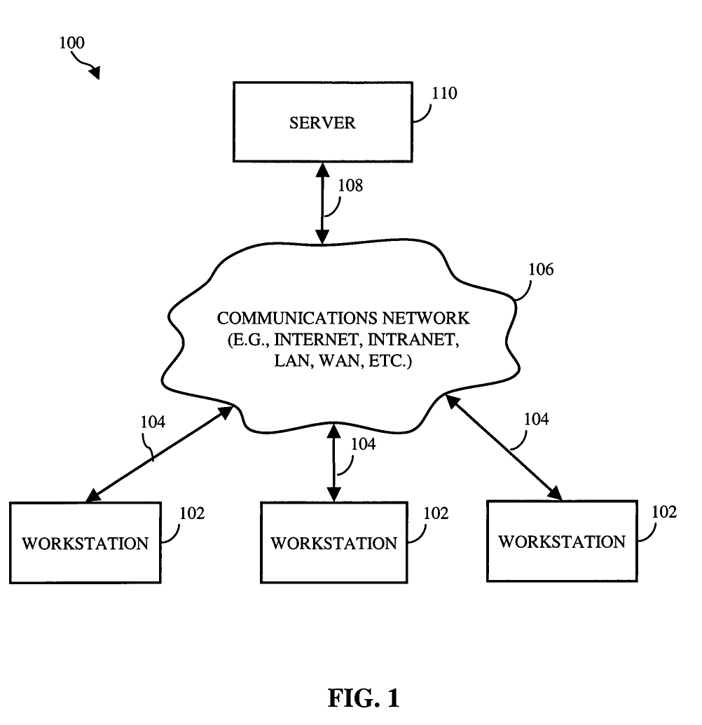

FIG. 1 is a schematic diagram of an illustrative system 100 suitable for implementation of a tracing application that stores and analyzes product history data to determine root causes of performance anomalies and/or field failures in accordance with one or more embodiments of the present invention. System 100 may include one or more workstations 102. Workstations 102 may be personal computers, laptop computers, mainframe computers, dumb terminals, data displays, Internet browsers, personal digital assistants (PDAs), two-way pagers, wireless terminals, portable telephones, etc., or any combination of the same. Workstations 102 and server 110 may be located at any suitable location. In one embodiment, workstations 102 and server 110 may be located within an organization. Alternatively, workstations 102 and server 110 may be distributed between multiple organizations. Workstations 102 may be connected by one or more communications links 104 to a communications network 106 that is linked via a communications link 108 to a server 110. For example, workstations 102 may be owned, operated, or used by universities, businesses, governments, non-profit organizations, families, individuals, or any other suitable person and/or entity. Any number (including only one) of workstations 102 may be present in system 100.

Server 110 may be any standard server for providing access to a tracing application. Communications network 106 may be a suitable computer network such as the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination thereof. Communications links 104 and 108 may be any communications links suitable for communicating data between workstations 102 and server 110, such as network links, dial-up links, wireless links, hard-wired links, etc.

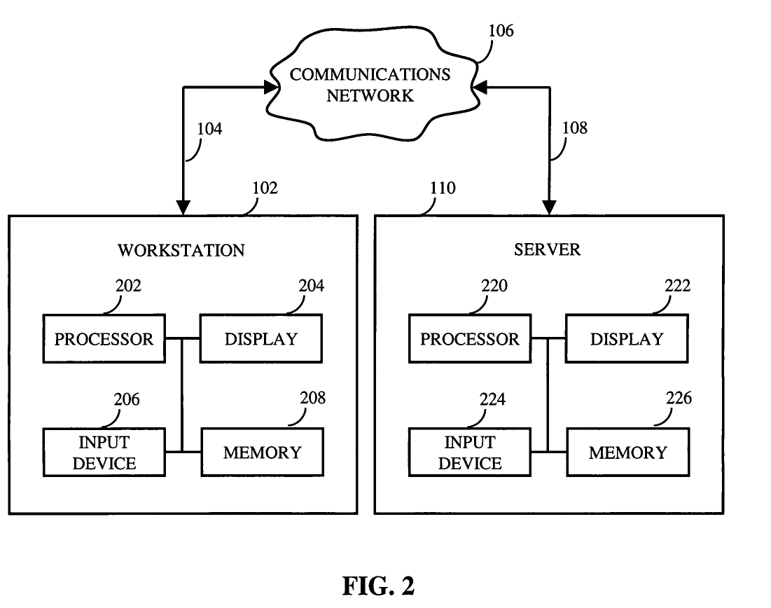

Server 110 and one of workstations 102, are illustrated in more detail in FIG. 2. Referring to FIG. 2, workstation 102 may include processor 202, display 204, input device 206, and memory 208, which may be interconnected. In one or more embodiments of the present invention, memory 208 contains at least one storage device, such as random access memory and a standard hard disk, for storing a workstation program for controlling processor 202.

In one or more embodiments, the tracing application may include an application program interface (not shown), or alternatively, as described above, the tracing application may be resident in the memory of workstation 102 or server 110. The tracing application may include client-side software, hardware, or both. For example, the application may encompass one or more Web-pages or Web-page portions (e.g., via any suitable encoding, such as HyperText Markup Language (HTML), Dynamic HyperText Markup Language (DHTML), Extensible Markup Language (XML), JavaServer Pages (JSP), Active Server Pages (ASP), or Cold Fusion).

Although the application is described herein as being implemented on workstation 102 or server 110, this is only illustrative. The application may be implemented on or used in connection with a variety of standard hardware (e.g., a personal computer (PC), a mainframe computer, a dumb terminal, a data display, a two-way pager, a wireless terminal, a portable telephone, a portable computer, a palmtop computer, an automobile PC, a laptop computer, a personal digital assistant (PDA), a combined cellular phone and PDA, etc.) to provide such features.

Processor 202 uses the workstation program to present on display 204 the application and the data received through communication link 104, and commands and values transmitted by a user of workstation 102. It should also be noted that data received through, for example, communication link 104 may be received from any suitable source, such as WebServices. Input device 206 may be a standard computer keyboard, a cursor-controller, a dial, a switchbank, lever, or any other suitable input device as would be used by a designer of input systems or process control systems.

Server 110 may include processor 220, display 222, input device 224, and memory 226, which may be interconnected. In a preferred embodiment, memory 226 contains a storage device for storing data received through communication link 108 or through other links, and also receives commands and values transmitted by one or more users. The storage device can further include or utilize a server program for controlling processor 220.

It should be noted that the present invention is primarily described herein in terms of a tracing application. The tracing application may be implemented by software, hardware, or both configured. The tracing application may located at, for example, a central location (e.g., a central server at a manufacturer), or among different locations (e.g., a network).

In one embodiment, the tracing application may include and/or utilize client-side software, hardware, or both. For example, the tracing application may encompass one or more Web-pages or Web-page portions (e.g., via any suitable encoding, such as HyperText Markup Language (HTML), Dynamic HyperText Markup Language (DHTML), Extensible Markup Language (XML), JavaServer Pages (JSP), Active Server Pages (ASP), or Cold Fusion).

Although the tracing application is described herein as being implemented on user computer equipment, the tracing application may also be implemented on any suitable platform (e.g., personal computer (PC), mainframe computer, dumb terminal, data display, two-way pager, wireless terminal, portable telephone, portable computer, palmtop computer, H/PC, automobile PC, laptop computer, personal digital assistant (PDA), combined cellular phone and PDA, etc.).

User(s) at workstation(s) 102 may perform operations, such as determining the source of a failure by providing information and by otherwise interacting with the tracing application. The tracing application may provide a user at workstation 102 with screen displays containing various product and/or component information. For example, the user may be presented with screens that allow the user to input product information (e.g., identification information), view and update any suitable information relating to the user (e.g., a consumer), or any other suitable screen in connection with the product.

The tracing application may provide the consumer, manufacturer, supplier, or other users with, for example, interactive screens containing menus and selectable options that allow the user to navigate through the tracing application and participate in the tracing application. With workstation 102, the user may use a keyboard, mouse, trackball, touch pad, or other input or pointing device to navigate the various menus and selectable options.

The user may access the tracing application with workstation 102. The user may access the tracing application by, for example, browsing to an Internet web site or a site on a private network, by running a local program, or any other suitable method.

The system according to the invention may include a general purpose computer, or a specially programmed special purpose computer. The user may interact with the system via e.g., a personal computer or over PDA, e.g., the Internet an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processing could be controlled by a software program on one or more computer systems or processors, or could even be partially or wholly implemented in hardware.

Although a single computer may be used, the system according to one or more embodiments of the invention is optionally suitably equipped with a multitude or combination of processors or storage devices. For example, the computer may be replaced by, or combined with, any suitable processing system operative in accordance with the concepts of embodiments of the present invention, including sophisticated calculators, hand held, laptop/notebook, mini, mainframe and super computers, as well as processing system network combinations of the same. Further, portions of the system may be provided in any appropriate electronic format, including, for example, provided over a communication line as electronic signals, provided on CD and/or DVD, provided on optical disk memory, etc.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

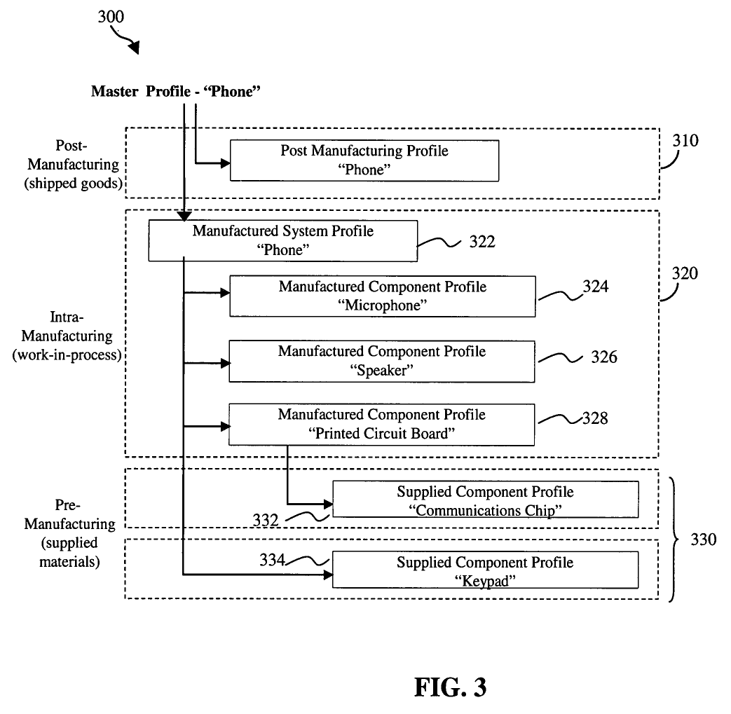

FIG. 3 is an illustration of a master profile 300 in accordance with one or more embodiments of the present invention. The master profile 300 may be used to characterize a product, its components, and associated component attributes. For example, FIG. 3 shows a master profile 300 for a “phone” product. The master profile 300 includes a post-manufacturing profile 310, an intra-manufacturing profile 320, and a pre-manufacturing profile 330. The phone is the manufactured system, which includes manufactured parts (e.g., a microphone, a speaker, and a printed circuit board) and supplied parts (e.g., a communication chip and a keypad). Each of these components preferably has its own product profile. For example, the supplied, pre-manufactured keypad has a corresponding product profile. As a result, master profile 300 may include a plurality of product profiles associated with the product, the system, the manufactured parts and/or the supplied parts. Master profile 300 may include as many individual product profiles that are necessary to characterize the product and its individual parts or components, and their relationship (e.g., hierarchical) with respect to each other.

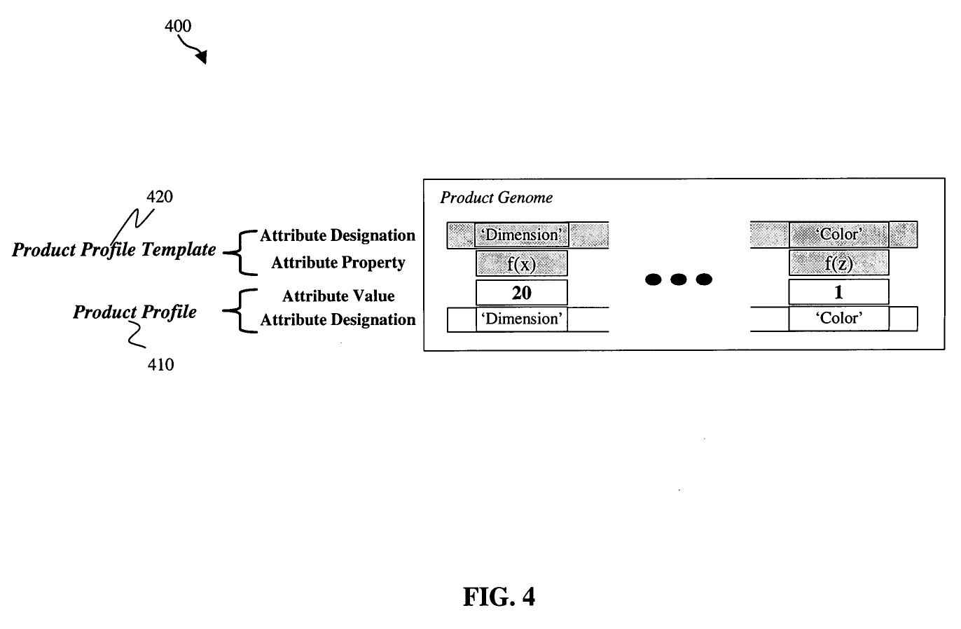

FIG. 4 is an illustration of a product genome 400 in accordance with one or more embodiments of the present invention. As shown in FIG. 4, product genome 400 describes the product in terms of product profiles 410 and product profile templates 420. In some embodiments, the product genome 400 may also include behavior profiles. This schema may be used to provide a common structure for each product and for each product type, and advantageously store the data in an efficient manner. The product's life history can be consolidated into a product genome 400 organized according to each product and constituent parts.

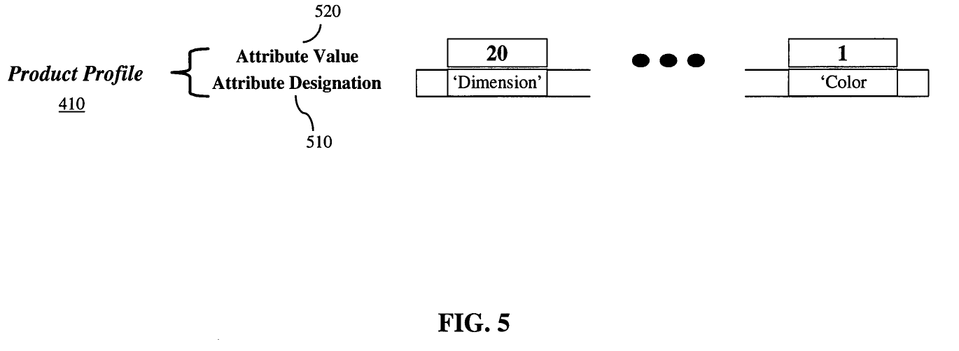

FIG. 5 shows an illustration of a product profile 410 in accordance with one or more embodiments of the present invention. Product profile 410 consists of a one or more attribute designations 510, and one or more corresponding attribute values 520. Attribute values 520 may be calculated, derived or arranged to correspond with a product profile template by applying an attribute property to corresponding data items from collected records. For example, product profile 410 shown in FIG. 5 has the attribute designations 510 of “dimension” and “color” and attribute values 520 corresponding to each of the designations 510. Attribute values 520 may be representations or calculations of the attribute designations 510. A user may specify, for example, at least as many product profiles as there are products and component parts.

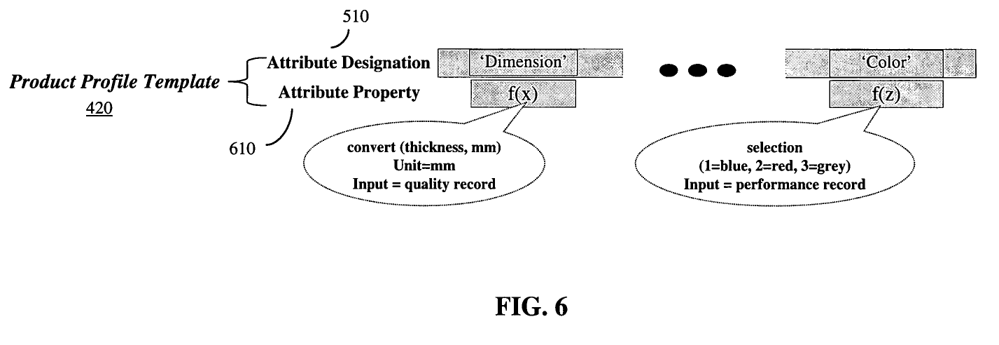

FIG. 6 shows an illustration of a product profile template 420. As shown in FIG. 6, product profile template 420 may include a plurality of attribute designations 510 and a plurality of attribute properties 610 that correspond to each of the attribute designations 510. Attribute properties 610 in the product profile template 420 are preferably used to indicate how attribute values from a product profile are to be collected, validated, calculated and/or represented. For example, as shown in FIG. 6, a “Color” attribute designation 510 is stored as an attribute value of “1,” “2” or “3” in the product profile 410. The product profile template 420 may assign or cross-reference each attribute value to particular attribute property 610. Thus, “1,” “2” and “3” may be assigned to respective attribute properties of “Blue with White Pin Stripes,” “Red with Green Swirls” and “Grey with Purple Spots.” In another example, the attribute property 610 may be a function, formula or equation for calculating a value that corresponds to the attribute designation 510. Any suitable attribute value may be collected, validated, calculated, or represented.

Separating attribute properties 610 in the product profile template 420 from attribute values 520 in the product profile 410 allows products to share attribute properties 610 for the same product or component type, and attribute values 520 for common products and/or parts (e.g., case of batched parts).

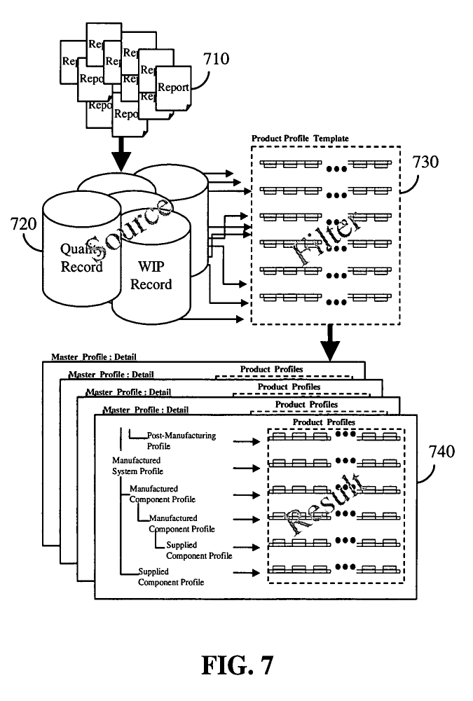

FIG. 7 is an illustration of how a product profile template 420 may be used in connection with a plurality of product profiles. As shown in FIG. 7, reports 710 or any other suitable data received from a user (e.g., a manufacturer, a supplier, an end user, etc.) may be stored in one or more databases or repositories 720. The data stored in databases 720 may be applied to one or more product profile templates 730. For example, product profiles 410 may be generated by applying attribute properties 610 from one or more product profile templates 730 to the stored data. Upon generating one or more product profiles using stored data 710 and product profile templates 730, a master profile 740 may be generated that includes the one or more product profiles that are associated with the product, the system, the manufactured parts, the supplied parts, etc.

An attribute designation 510 represents a feature or characteristic of a product and/or its component parts. Examples of attributes include identification (e.g., product name, serial number, manufacturer, etc.), logistics (e.g., recipe, process tool identification number, operator, etc.), metric (e.g., thickness, dimensions, strength, etc.), disposition (e.g., pass, fail, rework, etc.), and text strings (e.g., “strange mark in . . . ”). The users may define attribute designations 510, attribute values 520 and attribute properties 610 by, for example, utilizing values from collected records to characterize the product. Alternatively, the user may input information from collected records (e.g., product history, manufacturing logs, etc.) and the tracing application may use the inputted information to generate same thing.

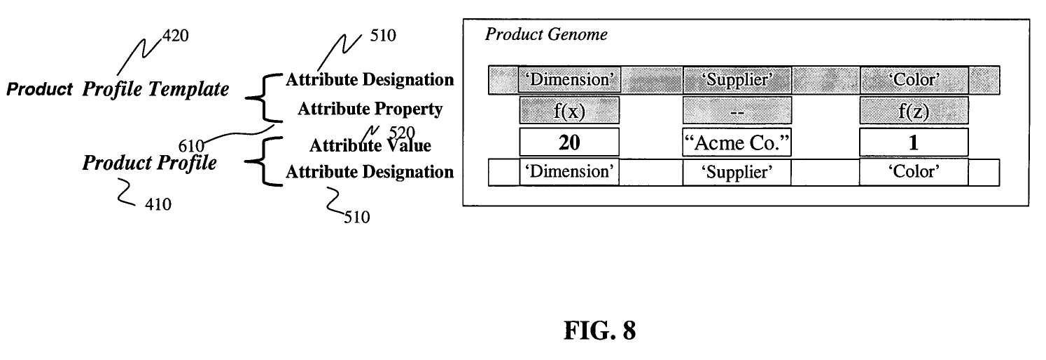

Similar to FIG. 4, FIG. 8 is an illustration showing a product profile templates 420 and a product profile 410. An attribute designation 510 identifies a specific attribute, such as a dimension, a supplier and/or a color.

An attribute property 610 may include information that identifies, describes and/or specifies the calculation of the attribute value 520. For example, attribute values 520 may be calculated mathematically, such as by translation, or logically, based for example, on match criteria. The attribute calculation may specify one or more inputs taken from the component's collected data (e.g., a trace record), and/or attributes from another product profile 410. If no attribute calculation is specified, the raw value input from one or more collected reports may be used. Alternatively, an attribute property 610 may specify how to generate an attribute value 520 (e.g., using a particular value inputted by the user, providing an instruction to retrieve a particular value in a given data repository, etc.).

An attribute value 520 may be defined by its attribute property 610, and may be the calculated result of applying the attribute property's value calculator to a collected data item. Attribute values 520 may be contained in the product profiles 410.

Breaking down the product into its individual components allows product profiles 410 to be constructed or developed in a “bottom-up” manner. For example, product profiles 410 may include data pertaining, for example, to supplied materials, manufacturing operations, distribution (e.g., shipped goods), and/or usage. The profiles are linked as the product goes through the supply chain. At the end of the supply chain, these linkages advantageously facilitate and/or permit tracing back to any point of the product's life history.

In some embodiments, a master profile 740 may include several types of product profiles 410. Referring back to FIG. 3, product profiles can include a post manufacturing profile 310, a manufactured system profile 322 with zero or more manufactured component profiles 324, 326, 328, and/or zero or more supplied component profiles 332, 334. The post manufacturing profile 310 may include, for example, packaging, distribution, usage, maintenance, and/or shipping/receiving data. The manufactured system profile 322 may represent attributes associated with the manufacturing of the product as a whole. For example, the manufactured system profile 322 may represent attributes pertaining to final assembly, final cleaning, final inspection, and/or quality assurance (QA). The manufactured component profile 324, 326, 328 may represent, for example, attributes associated with the product's manufactured part or parts. The manufactured component profile 328 may include, for example, one or more other manufactured component and/or supplied component profiles. The supplied component profile 332, 334 may represent, for example, attributes associated with any of the product's parts or raw materials that are sourced from outside suppliers.

In the example of FIG. 3, the phone is the manufactured system, which includes a microphone, a speaker, and a printed circuit board, as manufactured parts. In addition, a communication chip and keypad are the supplied part components. Each of these components has its own product profile.

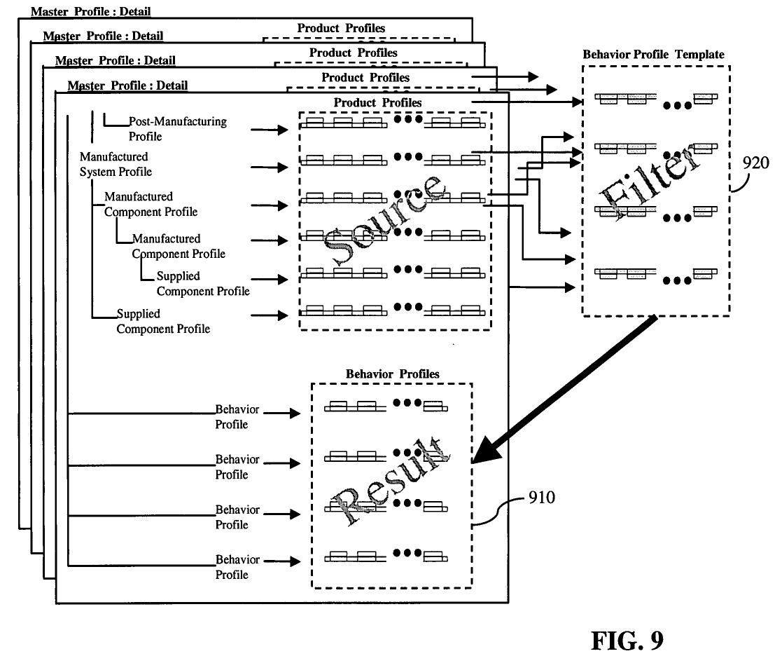

A behavior profile may provide an indication of how likely a product or component is to exhibit a given behavior. FIG. 9 is an illustration of one example of a behavior profile 910 that is derived from a behavior profile template 920. As shown in FIG. 9, behavior profile 910 is calculated from behavior profile template 920 by applying its attribute properties 610 to attribute values 520 from product profiles 410. Behavior profile 910 may be associated with one or more product profiles (e.g., product profiles 410).

Behavior profile template 920 may have the same structure as a product profile template (e.g., product profile template 420). For example, a behavior profile template 920 may access and use the same structure as a given product profile template 420. The structure, however, is used to specify attribute properties 610 that define attributes that characterize a specific behavior. The attribute properties 610 are applied to attribute values 520 contained in the product profiles 410 to generate behavior profiles 910. For example, a behavior attribute may include product life, likelihood that a product will exhibit a given behavior, probability that a component of a product will fail after a given amount of time, etc. A behavior profile 910 calculated using, for example, a behavior profile template 920 and a product profile template 420 may include information, such as component X in product Y tends to need replacement or refilling after 90 days, product Y has been recalled twice in its lifetime, there is a 30% chance that component X will deform if exposed to high temperatures, component X is faulty when a particular fault or event occurs, etc.

Behavior profile template 920 may include a combination of product attributes that are suspected or known to cause a specific behavior. Behavior profile templates 920 are generally established from knowledge and experience gained about the product over time. A user may define as many behavior profile templates 920 as desired to reflect the universe of known or understood product behaviors.

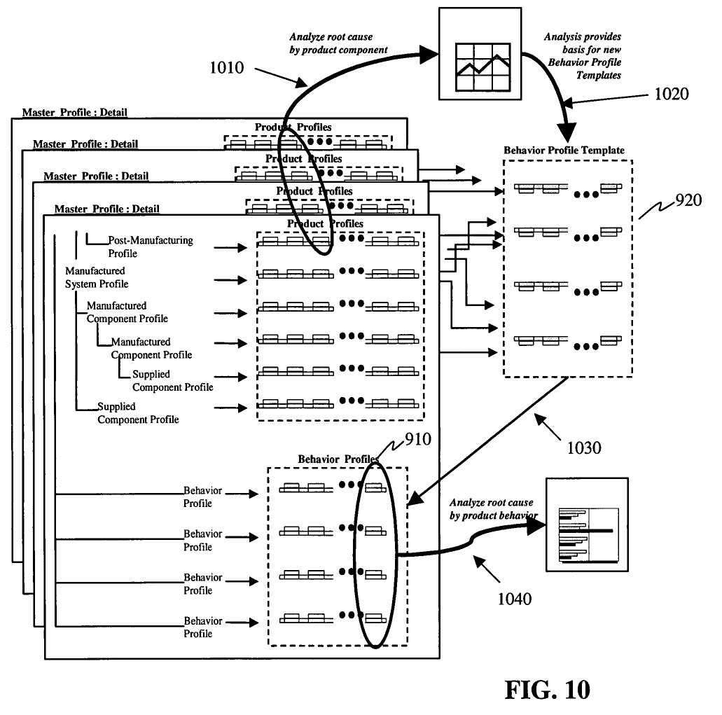

FIG. 10 is an illustration showing how a profile analysis can be performed on profiles of multiple products and/or components that share the same profile templates. As shown in FIG. 10 at 1010, profile analysis is performed on profiles of multiple products and/or components that share the same profile templates. For example, in FIG. 10, two types of analysis are defined: a product profile analysis (e.g., 1010) and a product behavior analysis (e.g., 1040). When performing a product profile analysis 1010, multiple products' profiles 300 may be analyzed to isolate one or more attribute(s) that may characterize a component or behavior. The isolated attributes may then, in turn, be applied to behavior profile templates 920 to create behavior profiles 910 (1030). The generated behavior profiles 910 may be analyzed for determining the root cause of the failure by product behavior (1040).

When performing a product behavior analysis, behavior profiles 910 may be used to search for characteristic patterns in products based on attributes known to be root causes of specific behavior. For example, the tracing application may search through all behavior profiles 910 for all products exhibiting the same behavior. The tracing application may then determine the attributes that the products have in common. Upon isolating these attributes, the tracing application may use found attributes to find other products' propensity to exhibit the same behavior, and/or used to improve or change the product behavior.

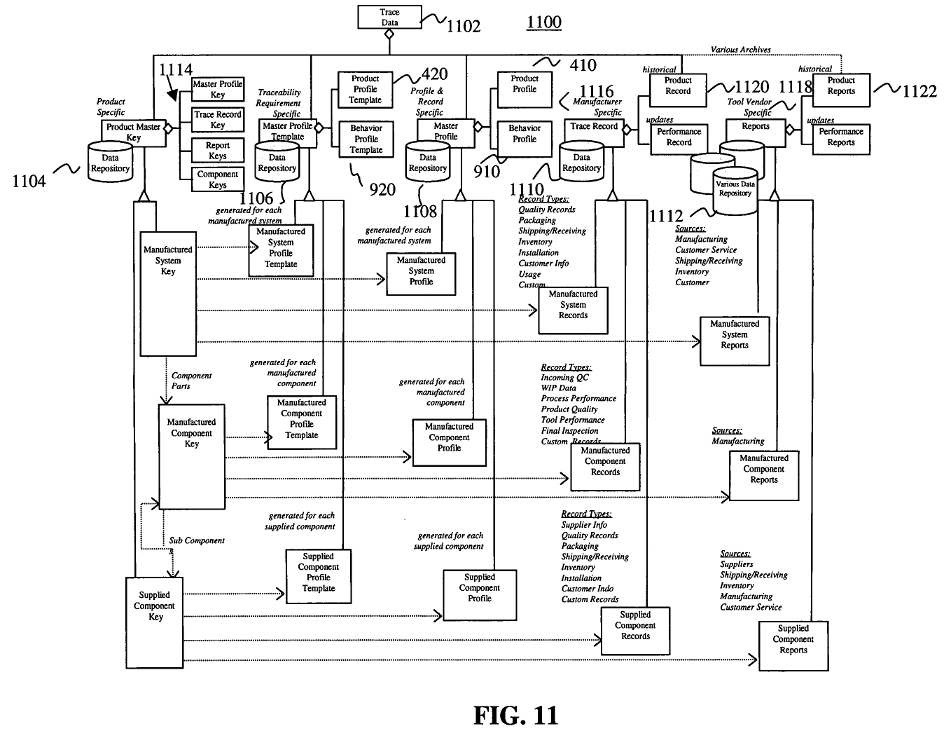

FIG. 11 is an exemplary data repository 1100. Repositories 1100 collectively includes trace data 1102, which may include Product master key 1104, master profile template 1100, master product profile 1108, trace record 1110 and reports repositories 1112.

In some embodiments of the present invention, the product master key repository 1104 may be implemented as a collection of manufactured system and component identifier entries. Manufactured system and component identifiers may contain one or more of the manufactured system's or component's identifiers (e.g., serial number, lot identification number, batch identification number, SKU number, etc.), references to associated trace data (sub parts) and/or associated profiles. Trace keys 1114 allow the tracing application to locate a product or behavior profile by a unique component identification number or by drilling down to any sub-component parts.

Product master key repository 1104 may facilitate, for example:
a. Normalization of trace keys 1114 collected throughout the product's life history. Normalization may advantageously facilitate a standardized access approach using, for example, a combination of product's serial number and its various parts' ID to trace all hardware and/or software components' historical data associated with the product;
b. Creation of a virtual product genome from multi-sited data sources logically connected through trace key references;
c. Enabling different levels of traceability according to customer capabilities, product, manufacturing and/or supplier level traceability; and/or
d. Sharing of common product profiles and product profile templates for batch or commodity components.

Master profile template repository 1106 may be implemented as a collection of product profile 420 and behavior profile 920 templates. As described above, a product profile template 420 generally defines the list of attribute properties 610 that will characterize the manufacture, distribution and use of the product. A behavior profile template 920 generally defines the list of attribute properties 610 that are known or suspected to affect product behavior.

A product profile template 420 may be assigned to a specific component or shared among multiple components of the same type. A product profile template entry can be created for the product and all of its traceable components. A behavior profile template 920 entry may be created by the user based, for example, on experience and/or knowledge about the product and its past performance. For example, when a user identifies that a product exhibits a given behavior, the user may access the tracing application and input the behavioral information relating to the product using a behavior profile template.

Profile template repository 1106 may provide the following exemplary functionality and/or features:
1. Allow users to define trace-specific attributes from specifying mathematical and/or logical operations to be performed on collected data.
2. Allow the quantification and automation of knowledge gained through experience by facilitating the recording and association of known contributors (attributes) to specific behaviors.
3. Build profiles on top of other profiles to allow for breaking down fault characterization into building blocks for more complex behavior characterization.
4. Allow standard packaging for reuse and exchange of product profile templates of the same or similar product/parts. A standardized set of attributes may be defined according, for example, to component type, processing, and/or industry application. The packaging and reuse feature may be shared, for example, among manufacturers producing same or similar products/parts.
5. Allow standard packaging for reuse and exchange of behavior profile templates 920 for known or suspected product/parts behavior. A standardized set of attributes may be defined according, for example, to specific failures, conditions and usage. The packaging and reuse feature may be shared, for example, among products that have a common use, failure, or conditions.
6. Allow or facilitate the exchange of profile templates between suppliers, manufacturers and/or end users for enforcing traceability capability compliance and/or ensuring the granularity of attributes collected for products/parts characterization.

Master profile repository 1108 may also be implemented as a collection of product profiles 410 and behavior profiles 910.

Product profiles 410 may be automatically generated once the specified attributes 510, 520, 610 are collected in trace records. A product profile entry may then be created for each product and at least some of its traceable components. Product profiles 410 may be used, for example, to locate patterns in attributes that may be isolated for analysis of causes of and/or correlation with specific product behavior (e.g., failure).

Master profile repository 1108 provides a representation of product life history data. In some embodiments, one or more product history values may be represented, for example, as bitmaps to facilitate storage and processing of relatively large amounts of product data.

Master profile repository 1108 provides the following exemplary functionality and/or features:
1. Allows standard packaging for reuse and/or exchange of product profiles 410 and/or behavior profiles 910 between suppliers, customers and/or end users, for example, for use in connection with validation of traceability requirements compliance.
2. Allows or facilitates the exchange of product profiles 410 and/or behavior profiles 910 between suppliers, manufacturers and/or end users as part of the quality data delivered with the product/part, for example, as part of a traceability compliance requirement.

Trace record repository 1110 may be implemented as a collection of trace records 1116 containing data items from various collected product reports. These data items are known or suspected to best (or satisfactorily) characterize a component and affect product behavior. The trace record data items are the inputs for generating attribute values in product profiles.

Each manufactured system or component type may have or utilize its own set of quality records. Manufactured systems may have, for example, quality records, packaging, shipping and receiving, inventory, installation, maintenance, usage, customer info, and/or user custom specified trace records. Manufactured components may have, for example, incoming quality control, logistics data, process performance, product quality, tool performance, final inspection, and/or user custom specified trace records. Supplied components may have, for example, supplier information, quality records, shipping and receiving, inventory, packaging, or user custom specified trace records.

Trace record repository 1110 may advantageously be used to collect data from various sources throughout the product's life history, and consolidate the data into trace useable reports. Trace record repository 1110 data sources may include and/or utilize data pertaining to, for example:
a. Manufacturing Execution Systems (MES), and its various applications, which automate the manufacturing operations.
b. Work In Progress (WIP), which tracks materials through the manufacturing process.
c. Supply Chain Management (SCM), which generally involves the planning, scheduling and control of the supply chain, generally to reduce inventory. A supply chain may include organizations and/or sequential, non-sequential and/or sequence independent functions that mine, make and/or assemble materials and products from manufacturer to wholesaler to retailer to consumer.
d. Enterprise Resource Planning (ERP), which may include and/or utilize software for manufacturing, order entry, accounts receivable and payable, general ledger, purchasing, warehousing, transportation and/or human resources.
e. Statistical Process Control (SPC), which generally involves trend monitoring of product quality, process and/or operations performance.
f. Advanced Process Control (APC), which generally profiles close loop and advance modeling techniques for process optimization.
g. Distribution and Warehousing, which generally tracks product distribution to various customers/retailers and warehouses.
h. Supplier Management, which generally tracks suppliers and supplied parts.
i. Inventory Management, which manages and tracks inventory of parts and products.
j. Customer Relations Management (CRM), which is generally implemented as an information system that is used to plan, schedule, control and/or monitor the pre-sale(s) and post-sale(s) activities in an organization.
k. Tracking of shipping and receiving inventor and/or orders.
l. Usage Monitoring, which generally involves tracking product usage from customers to suppliers. Usage monitoring may be performed, for example, by a government agency such as the Food and Drug Administration (FDA).
m. Quality Control (QC), which generally manages and/or documents incoming parts and materials quality.
n. Quality Assurance (QA) Management, which generally involves the process of ensuring that products and systems perform as originally specified.
o. Customer Service Management, which may include or involve repair and maintenance functions and/or services.
p. Product Lifecycle Management (PLM), which may utilize, for example, an information system to coordinate aspects of a product from, for example, initial concept to retirement. PLM is also referred to as the “digital backbone” of a product, and may include a requirements phase, an analysis and design stage, as well as manufacturing, product launch, distribution, quality assurance, in-service maintenance and/or spare parts provisions.

In operation, the trace record repository 1110 may be used to standardize the definition and content of trace-specific records for a manufacturer and supplier, transform collected raw data from, for example, various suppliers, tracking, MES, ERP and/or SCM, into trace data, and/or format the trace data so that it may be provided as output in the form of a report.

Separation of trace records, 1116 from master profiles advantageously allows archiving of trace records 1116 to free resources until, for example, new profile templates are defined and product profiles are re-generated.

Some embodiments may also use several sources of data, optionally located throughout or within various portions of the supply chain. Such data sources are sometimes referred to herein as “reports.” Reports 1118 may be generated or provided, for example, by manufacturers, suppliers, customer service, shipping/receiving, customers and/or users. Reports 1118 may include data from a database or a file system, paper printouts, or any other suitable report. Reports 1118 may be stored and indexed, for example, in a central report repository 1112, which may be used, for example, to supplement defined trace records.

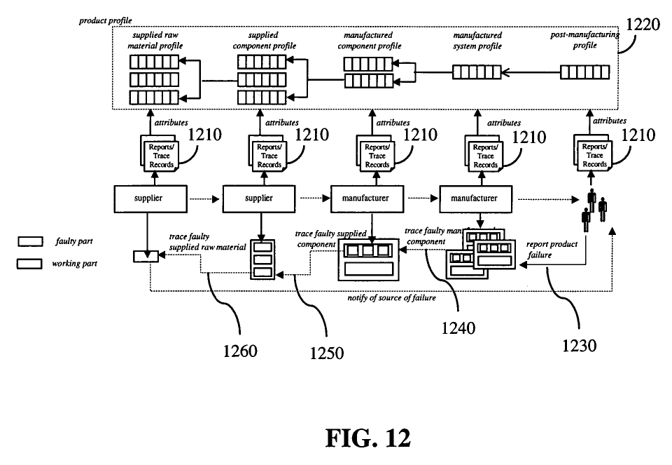

FIG. 12 is a simplified illustration of one example of how the tracing application allows users to trace faulty parts back to a supplier in accordance with some embodiments of the present invention. Product reports and records 1210 are inputted into the tracing application, which in turn generates a product profile 1220 that embodies each stage of the product's life cycle. Product reports 1210 that may be exchanged between one or more suppliers and one or more customers include, for example, quality reports, compliance reports, supplier information and/or performance reports. Supplier traceability facilitates or provides the ability to trace faulty parts back to the suppliers, and optionally further back into the supply chain to, for example, an originating supplier. One or more of the suppliers in a supply chain may perform their own root cause analysis and provide this information with respect to a supplied part and/or their own manufactured part.

A product report 1210 may be generated by each of the suppliers in the supply chain and linked together by the product profile as a part is passed from a supplier to a customer. At or near the end of the supply chain, the product profile 1220 will will include data that associates suppliers for all or substantially all of the product's supplied parts.

As shown in FIG. 12, the tracing application may allow users to isolate a faulty supplied raw material and trace the faulty supplied raw material back to a supplier. In response to users (e.g., customers, end users, etc.) reporting a product failure (step 1230), the manufacturer may use the tracing application to isolate the faulty supplied raw materials using product profiles and behavior profiles to determine common features of faulty parts and isolate the root cause by product component 1010 or product behavior 1040. For example, the manufacturer may use repository 1100 to trace the one or more common manufactured components used to manufacture the faulty manufactured systems (step 1240), trace through the one or more common supplied components used to manufacture the manufactured components for the faulty manufactured systems (step 1250), and/or trace through the common supplied raw materials used in making the supplied components for the faulty manufactured systems (step 1260). Upon determining one or more faulty supplied raw materials, the manufacturer may query repository 1100 to determine the supplier of the faulty supplied raw materials. The manufacturer may then provide the supplier of the faulty part with a notification.

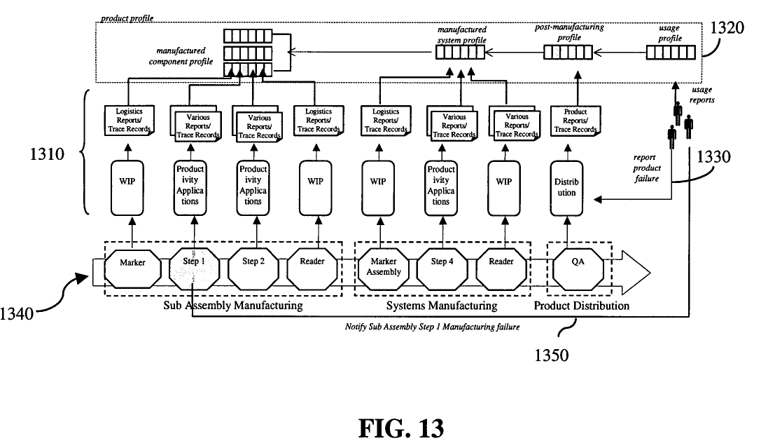

FIG. 13 is a simplified illustration of one example of how repository 1100 may allow manufacturers to identify manufacturing sources of failures from the manufacturing processes used to produce the product in accordance with some embodiments of the present invention. As shown in FIG. 13, the tracing application may include a manufacturing traceability feature or capability that allows manufacturers to trace product behavior to manufacturing processes that are used, for example, to identify manufacturing sources of failures.

Product history may be assembled from logistics data and/or various reports and records 1310 collected and consolidated throughout the manufacture of the product. Logistics data may be collected from various tracking systems and organized to reflect the composition of a product. Product reports may be generated by various productivity systems, such as SPC, quality control, and/or process performance, and consolidated into trace records used for building profiles. The combination of a product composition based “trace tree” may be related to or used in connection with manufacturing reports and records to advantageously enable or facilitate tracing product behavior (e.g., failure) to one or more operations in the manufacturing process. Logistics data and/or various reports and records 1310, which relate to product profile 1116 and report 1118 shown in FIG. 11, may be inputted into the tracing application, which generates a product profile 1320 that includes data relating to the product throughout each manufacturing step.

As shown in FIG. 13, in response to a user reporting a product failure 1330, the manufacturer may use repository 1100 to determine the source of the failure. For example, in response to receiving a notification from one or more users regarding a faulty product, the manufacturer may use the tracing application to determine where the fault occurred in the manufacturing processes used to produce the faulty product. For example, the tracing application may determine that the product was manufacturered by a unique process in a plant in New York. In response, the tracing application may then determine which step of the manufacturing process may have caused the fault. Alternatively, the tracing application may notify the plant or manufacturer where the fault may have occurred and prompt the manufacturer to ascertain the source of the fault. Upon determining the source of the fault, the tracing application may notify the manufacturer of the source of the fault.

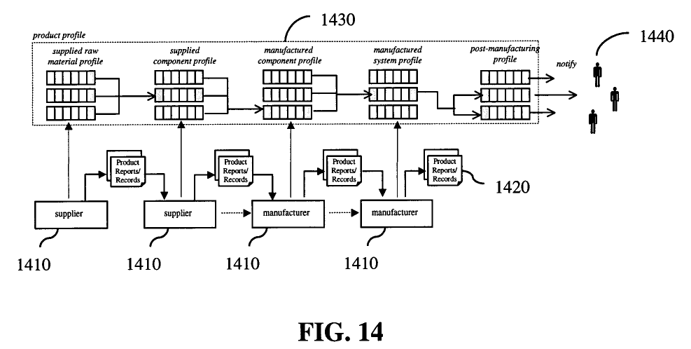

FIG. 14 is an illustration of one example of how the tracing application allows a user or customer having faulty products or products having faulty components to be traced in accordance with some embodiments of the present invention. As shown in FIG. 14, the tracing application allows deployed products to be traced. Once a product is provided to a customer 1440, the customer 1440 is tracked by associating the customer information to the product profile 1430. As described previously and as shown in FIG. 14, product reports 1420 may be shared with other manufacturers 1410 along the supply chain and may be inputted along with other data from the manufacturers 1410 to generate a product profile 1430. Each product that is provided to a user may have a product profile 1430 that includes a supplied raw material profile, a supplied component profile, a manufactured component profile, a manufactured system profile, and/or a usage profile. When a faulty product is discovered, repository 1100 may use the product profile to determine other products which may also be faulty (e.g., because the products were made using the same process, because the products use the same materials, because the products use components from the same supplier, etc.). Once the other affected products are identified, trace records 1116 in repository 1100 may be queried to identify the customers that are associated with the affected products. This customer traceability feature of the tracing application may advantageously be used to contact customers and/or end users in connection with fault notifications and product recall.

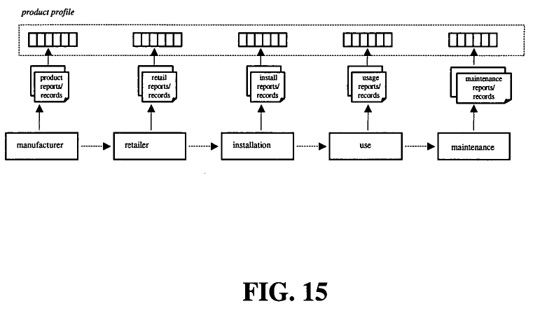

FIG. 15 is an illustration showing how repository 1100 the tracing application links trace data after the product has been manufactured and distributed to customers. As shown in FIG. 15, a field traceability feature of the repository 1100 allows users to provide additional trace data after the product has been manufactured and distributed to customers. For example, as indicated with reference to FIG. 11, various records can contain information pertaining to customer information, usage, installation, and the like. After distribution, the product may pass between different users such as retailers (e.g., hospitals), installers (e.g., doctors), users (e.g., patients), and maintenance (manufacturers). Product profiles 410 provide the ability to capture performance reports and performance records from various users and consolidate them with the product's collected manufacturing history. The combination of field performance and historical manufacturing data provides a comprehensive or substantially comprehensive traceability solution. For example, as indicated with reference to FIG. 11, various records can contain information pertaining to customer information, usage, installation, and the like. Field traceability may also be performed and reported, for example, by various product monitoring agencies (e.g., the FDA).

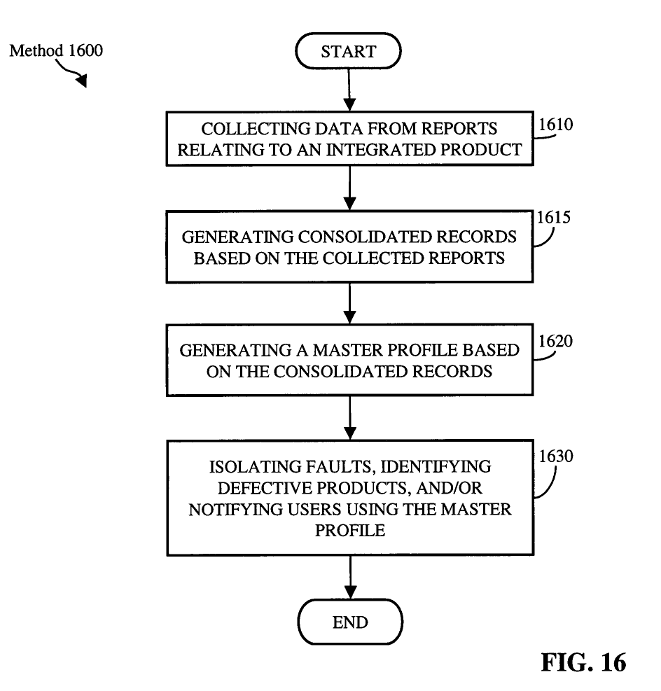

FIGS. 16-18 are generalized flow charts illustrating the steps performed in the storing and analyzing of product history data to determine causes of component and/or system failure.

FIG. 16 is an exemplary flowchart illustrating the steps performed in determining causes of component and/or system failure using a product profile that characterizes the integrated product and its constituent components in accordance with some embodiments of the present invention. At step 1610, the data is provided to repository 1100 from reports 1118 relating to an integrated product. The reports may include, for example, quality reports, installation reports, maintenance reports, customer information, quality control, logistics data, process performance data, tool performance data, supplier information, inventory, or any other suitable data. At step 1615, data collected from various sources throughout the integrated product's life history may be consolidated into trace useable records 1116. Alternatively, the user may input pertinent data relating to the integrated product using the tracing application.

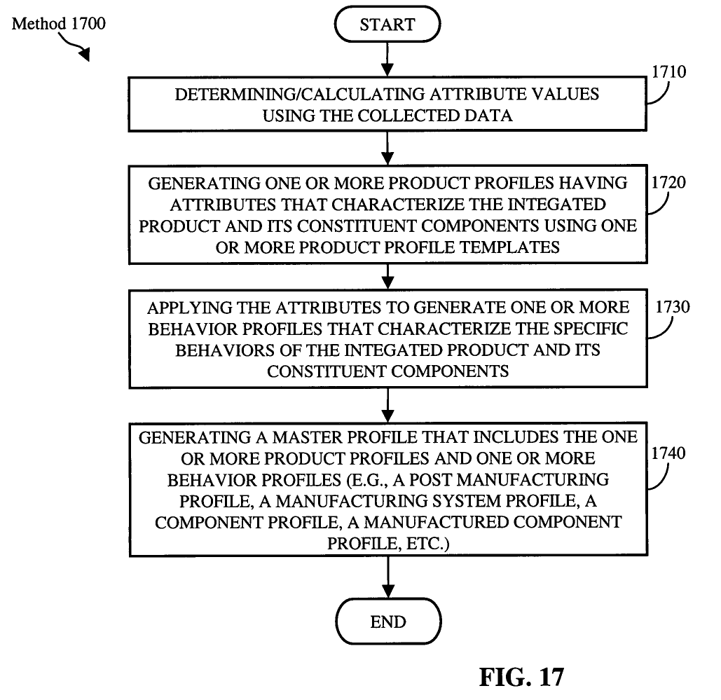

A master profile 300 is generated based on the collected data at step 1620. As described previously, a master profile may be used to characterize an integrated product, its constituent components, and associated component attributes. The master profile 300 generally includes one or more system and component profiles necessary to characterize the integrated product and its constituent components. The master product profile 300410 includes an integrated product's manufacturing, supplier, deployment, and usage history across its entire supply chain. The profile 300 consolidates various products' supplied materials logistics data with various reports (e.g., manufacturing, inspection, disposition, shipping, storage, and field performance reports) organized according to the products supplied materials. The profile may also consolidate various products' manufacturing logistics data with various reports (e.g., various manufacturing processes, metrology, inspection, disposition, and field performance reports) organized according to the products' manufactured parts. In addition, the profile may consolidate various products' deployment logistics data with various reports (e.g., inspection, disposition, distribution, shipping, and field performance reports) organized according to the deployed product. The steps performed in create a master profile are described in further detail in FIG. 17.

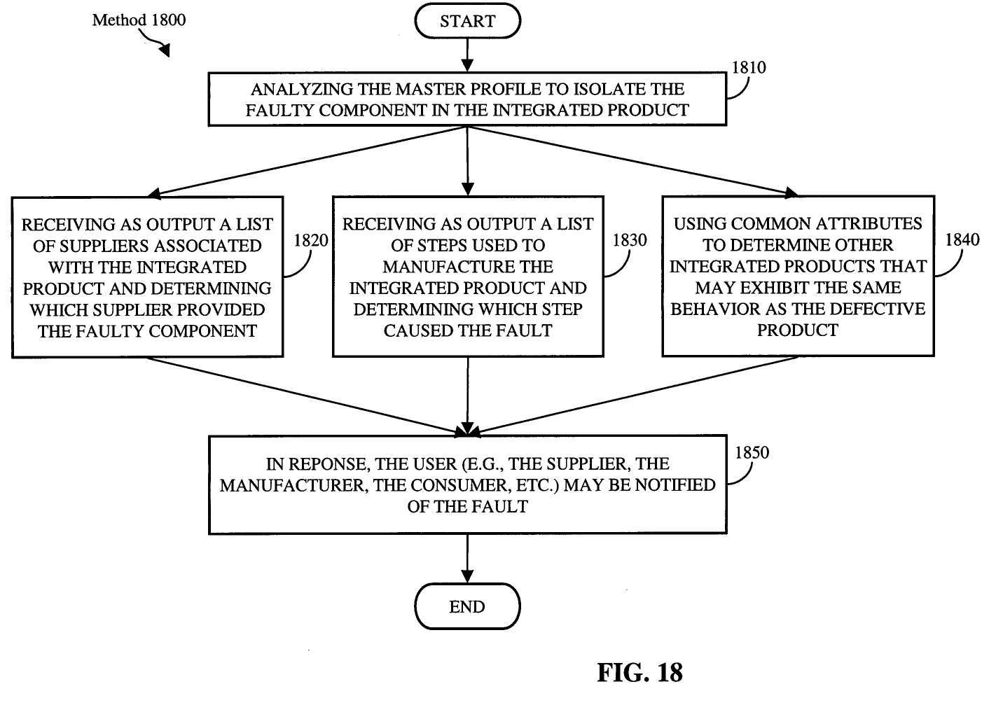

Using the master profile 300, the repository 1100 may be used to isolate faults in defective products, identify other defective products, and/or notify the appropriate users at step 1630). The steps performed in analyzing a master profile are described in further detail in FIG. 18.

FIG. 17 is an exemplary flowchart illustrating the steps performed in generating a master profile 300 having one or more product profiles 410 and one or more behavior profiles 910. At step 1710, attributes 510, 520, 610 may be determined or calculated using the collected data (step 1610 of FIG. 16).

Using attribute values 510, 520, 610, one or more product profiles 410 having attributes 510, 520 that characterize the integrated product and/or its constituent components may be generated (step 1720). For example, product profile templates 420 that are associated with the product profiles 410 may be used to specify how attributes are to be calculated, collected, validated, and/or represented in a product profile. Product profiles 410 may be generated by applying attribute properties 510, 610 from one or more product profile templates 420 to the collected data.

These attributes may also be used to generate one or more behavior profiles 910 that characterize the behavior(s) of the integrated product and its constituent components (step 1730). Behavior profiles 910 may, for example, provide an indication of how likely an integrated product or its component is to exhibit a given behavior. Similar to the use of product profile templates 420, behavior profile templates 920 may be used to specify attributes 510, 520 that characterize a specific behavior. In some embodiments, a user may define a behavior profile template 920 to reflect the universe of known or understood product behaviors (e.g., knowledge and experience gained about the product over time). A behavior profile 910 may be generated by applying the collected data to the attribute properties from the behavior profile template 920.

A master profile 300 that includes at least one of a product profile 410 and a behavior profile 910 may be generated. For example, a master profile 300 may include several types of product profiles 410 (e.g., a post-manufacturing profile, a manufactured system profile, a manufactured component profile, a supplied component profile, etc.).

The generated master profile may be used to, for example, analyze causes of component and/or system failure. FIG. 18 is an exemplary flowchart illustrating the steps performed in analyzing a master profile 300 to identify faults in integrated products and notifying the appropriate users regarding the fault in accordance with some embodiments of the present invention. At step 1810, the master profile 300 may be analyzed to isolate the common root cause 1010 of the faulty component in the integrated product. The isolated attributes may then, in turn, be applied 1020 to behavior profile templates 920 to create behavior profiles 910. The generated behavior profiles 910 may be analyzed to determine the common root causes of the failure by product behavior 1040. In some embodiments, repository 1100 may search through all behavior profiles 910 for all products exhibiting the same behavior and determine the attributes that the products have in common. Upon isolating these common attributes, the repository 1100 (specifically 1108) may be searched for these common attributes to find other products that have a propensity to exhibit the same behavior.

The isolated attribute may correspond to a particular component in the integrated product. In response to analyzing the master profile 300, the repository 1100 may provide a list of suppliers associated with the integrated product. The tracing application may then determine the supplier that provided the faulty component (step 1820).

In another embodiment, the isolated attribute may correspond to a particular process used to manufacture the integrated product. At step 1830, the repository 1100 may provide a list of steps used to manufacture the integrated product and determine which step caused the fault.

In yet another embodiment, repository 1100 may use the isolated attribute to find other possibly defective products. At step 1840, repository 1100 (specifically 1108) may be searched to determine other integrated products that exhibit the same behavior as the defective product using common attributes. For example, repository 1100 may determine that the fault occurred because of a faulty manufactured component. Repository 1100 may use the product profile 410 and its attributes 510, 520 to determine other products that use the faulty manufactured component. For example, as shown in FIG. 11, each manufactured component has its own manufactured component profile. In another example, repository 1100 may be searched to find other products that have been determined to have components similar to the faulty component.

Repository 1100 may used to notify the user of the fault at step 1850. For example, the repository 1100 may be used to provide the supplier with a notification in response to determining that the supplier provided the faulty component. In another example, the repository 1100 may be used to provide the manufacturer with a notification in response to determining that a particular process or step of a process caused the fault. For example, as shown in FIG. 11, each supplied component has its own supplied component profile. In yet another example, the repository 1100 may be used to provide customers or end users with a notification that a product is faulty. Such notifications may be structured, for example, as product recall notifications and fault notifications.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow. For example, in one suitable embodiment, a broker may be allowed to interact with the manufacturer. In some embodiments, the broker may be part of the manufacturer. Any other suitable arrangement may be used.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

1. A computer implemented method for identifying defective products from a plurality of products, the method comprising:
accessing a master profile associated with a defective product, wherein the master profile comprises at least one product profile having attributes that characterize the constituent components associated with the product;
analyzing the master profile by comparing the at least one product profile corresponding to the defective product with product profiles associated with each of the plurality of products to isolate a given attribute that caused the product to be defective; and
identifying a faulty component of the product based at least in part on the given attribute.

2. The method of claim 1, further comprising accessing a data repository having identification information relating to the plurality of products to determine the product corresponding to a product key.

3. The method of claim 1, wherein the master profile comprises at least one behavior profile having attributes that characterize a given behavior of the constituent components of the product.

4. The method of claim 1, wherein the at least one product profile includes information relating to the suppliers of the constituent components of the product, the method further comprising:
accessing the at least one product profile to determine which supplier that provided the faulty component.

5. The method of claim 1, further comprising searching through master profiles corresponding to the plurality of products to determine whether another product has the given attribute.

6. The method of claim 1, further comprising:
collecting data from reports relating to the defective product;
generating one or more attributes based at least in part on the collected data; and
storing the one or more attributes in the at least one product profile.

7. The method of claim 1, further comprising accessing the at least one product profile to determine the source of the faulty component.

8. The method of claim 1, further comprising identifying a manufacturing process used to manufacture the faulty component.

9. The method of claim 8, further comprising determining which operation within the manufacturing process manufactured the faulty component.

10. The method of claim 1, wherein the product profile comprises data pertaining to supplied material, supplied components, manufacturing processes, and post-manufacturing usage information.

11. The method of claim 1, wherein the attribute pertains to post-manufacturing activity comprising at least one of rework, installation, and shipping.

12. A computer implemented method for identifying suppliers of constituent components associated with an integrated product, the method comprising:
querying a data repository comprising at least one product profile having attributes that characterize the constituent components associated with the integrated product; and
generating a list of suppliers associated with the integrated product in response to querying the data repository.

13. The method of claim 12, wherein the querying the data repository further comprises comparing the at least one product profile corresponding to the integrated product with other product profiles to determine which constituent component caused the integrated product to be defective.

14. The method of claim 13, wherein the data repository includes at least one behavior profile having attributes that characterize a given behavior of the constituent components of the integrated product.

15. The method of claim 12, wherein the constituent components comprise at least one of a faulty manufactured system, a faulty manufactured component, and a faulty supplied component.

16. A computer implemented method for managing information relating to a plurality of products, the method comprising:
querying a data repository comprising at least one product profile having attributes that characterize the constituent components associated with an integrated product; and
generating a list of steps used to manufacture the integrated product in response to querying the data repository.

17. The method of claim 16, further comprising:
receiving an indication from a user that the integrated product is defective; and
querying the data repository to determine which step caused the integrated product to be defective.

18. The method of claim 16, wherein the step pertains to a manufactured component.

19. The method of claim 17, wherein the querying the data repository further comprises comparing the at least one product profile corresponding to the integrated product with other product profiles to determine which step caused the integrated product to be defective.

20. The method of claim 17, wherein the querying the data repository further comprises:
accessing a master profile associated with a defective product, wherein the master profile comprises the at least one product profile;
analyzing the master profile by comparing the at least one product profile corresponding to the defective product with product profiles associated with each of a plurality of products to isolate a given attribute that caused the product to be defective; and
identifying a faulty component of the defective product based at least in part on the given attribute.

21. The method of claim 17, wherein the step which step caused the integrated product to be defective is at least one of a portion of a systems manufacturing process and a portion of a product distribution process.

22. The method of claim 19, wherein information pertaining to the faulty component includes at least one of logistics data, manufacturing reports, inspection reports, disposition reports, shipping reports, field performance reports, manufacturing process reports, and metrology reports.
